(19) United States
(12) Patent Application Publication
(10) Pub. No.: US 2005/0084650 A1
(43) Pub. Date: Apr. 21, 2005

(54) Fabric throw apparatus and method of assembly

(76) Inventors: Ann Pollard, Andover, MN (US); Karen Ferlaak, Cottage Grove, MN (US); Deborah Hettinger, Hudson, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/882,948

(22) Filed: Jul. 1, 2004

(51) Int. Cl. B32B 3/02

(52) U.S. Cl. 428/115

(57) ABSTRACT

A fabric throw, a kit for making a fabric throw and a method of assembling a fabric throw are disclosed. The method can include providing a first layer of fabric material and a second layer of fabric material; cutting a plurality of slits along edges of the layers to form corresponding pairs of fringes from the layers; and knotting corresponding pairs of fringes to secure the first layer to the second layer.

### TECHNICAL FIELD

The present invention relates generally to the field of crafts and, more particularly, to a fabric throw and method of assembling a fabric throw.

### BACKGROUND

Persons interested in crafts and making personal items from materials such as fabrics are often in search of new and fun projects that can produce a useful and attractive item. Even people with little skill, such as in the areas of sewing or embroidery, and/or little time may be interested making an item, rather than buying a finished product from a merchant. Still others may be interested in purchasing a completed item. Accordingly, there is a need in the art for creative, yet relatively simple crafts projects. There is also a need for personal warmth items, such as blankets, shawls, throws and the like.

### SUMMARY OF THE INVENTION

According to one aspect of the invention, the invention is a fabric throw. The throw can include a first layer of fabric material and a second layer of fabric material wherein each layer defines a plurality of fringes along one or more edges of the layers, corresponding pairs of fringes are knotted together to secure the first and second layers to each other.

According to another aspect of the invention, a fabric throw includes at least two layers of fabric material, each layer defining a plurality of fringes along one or more edges of the layer, and corresponding pairs of fringes, at least one of one layer and one of a second layer, being knotted together to secure the layers to each other.

According to another aspect of the invention, a kit for making a fabric throw includes at least two layers of fabric material, each layer defining a plurality of fringes along one or more edges of the layer, and corresponding pairs of fringes, at least one of one layer and one of a second layer, being arranged to be knotted together to secure the layers to each other.

According to another aspect of the invention, the invention is a method of assembling a fabric throw. The method can include providing a first layer of fabric material and a second layer of fabric material; cutting a plurality of slits along edges of the layers to form corresponding pairs of fringes from the layers; and knotting corresponding pairs of fringes to secure the first layer to the second layer.

According to another aspect of the invention, a method of assembling a fabric throw that includes at least first and second layers of fabric-like material with fringes along an edge, includes knotting corresponding pairs of fringes to secure the first layer to the second layer.

According to yet another aspect of the invention, the invention is a kit for making a fabric throw. The kit can include a first layer of fabric material; a second layer of fabric material; and a set of instructions setting forth how to assemble the throw. In one embodiment, the instructions include a direction to cut the layers such that each layer has corresponding fringes and a direction to knot corresponding fringes to secure the first and second layers to each other.

### BRIEF DESCRIPTION OF DRAWINGS

These and further features of the present invention will be apparent with reference to the following description and drawings, wherein:

FIG. 1 is a top view of an assembled fabric throw according to the present invention;

FIG. 2 is an exploded view of the fabric throw prior to assembly; and

FIG. 3 is a top view of the fabric throw in an intermediate stage of assembly.

### DISCLOSURE OF INVENTION

In the detailed description that follows, like components have been given the same reference numerals, regardless of whether they are shown in different embodiments of the present invention. To illustrate the present invention in a clear and concise manner, the drawings may not necessarily be to scale and certain features may be shown in somewhat schematic form.

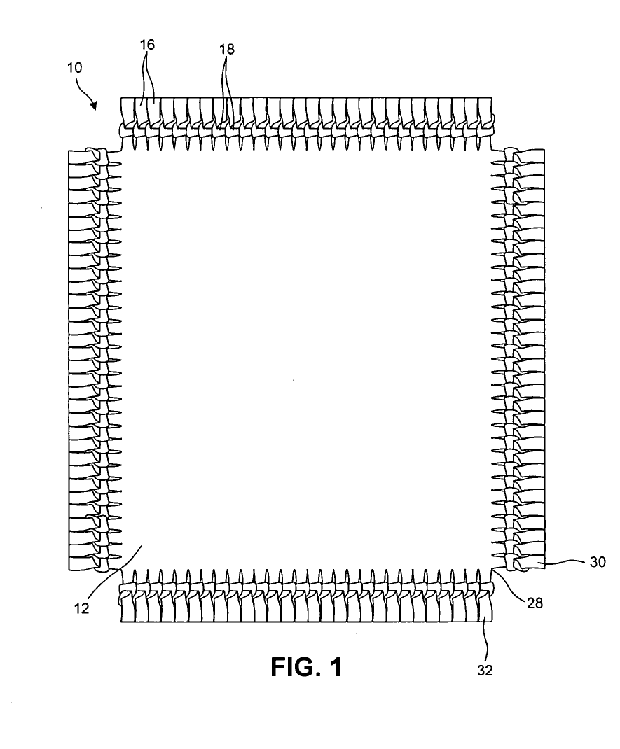

Referring to FIG. 1, shown is top view of an assembled fabric throw 10. The throw 10 is comprised of one or more layers 12. In one embodiment, there are two layers 12 of fabric material. In the view of FIG. 1 a second or bottom fabric layer 12 is hidden from view by a first or top fabric layer 12. The fabric can be made from any suitable woven or non-woven material, including, but not limited to, polyester, cotton, wool, and so forth. In one embodiment, the fabric is a polyester fleece material (commonly referred to as “polar” fleece material), which is known to have considerable softness and warmth. Polyester fleece material also has good workability for craft projects as this material resists tearing when cut. The material may be other than the mentioned materials.

Referring now to all of the figures, the layers 12 of the throw 10 have slits 14 between which are fringes 16 that may be tied as knots 18, as is described further below. The slits 14 are cut inward from edges 20 of the layers 12 to define fringes 16. The fringes 16 can be knotted to provide an interesting appearance to the throw 10. Corresponding sets or pairs of fringes 16 (e.g., one from the top layer 12a and one from the bottom layer 12b) can be knotted together such that the layers 12 are secured to one another. Knotting of the fringes 16 results in the formation of knots 18.

As should be appreciated, when the layers 12 are knotted together in this manner the throw 10 can be assembled without sewing or stitching. However, if desired, stitching can be added to further secure one layer 12 to another. Stitching can also be used to secure other items to the throw 10 (e.g., decals, patches, etc.), or for the purpose of embroidering the throw 10, adding quilting or damasking to the throw 10, securing filling material between layers 12 of the throw 10 and so forth. Optionally, some of the fringes 16 can be left unknotted.

In one embodiment, the throw 10 comprises two layers 12 of fabric that each define a plurality of fringes 16 along each edge 20 of the layers 12. Corresponding fringes 16 from each layer 12 are tied together to secure the layers 12 together. The throw 10 can used as a blanket. For instance, the throw 10 can be used for warmth or comfort when sitting in a chair or on a sofa while watching television or reading a book. Alternatively, the throw 10 can be used as bedding material. In other example uses, the throw 10 can be used as a wall hanging or as a rug.

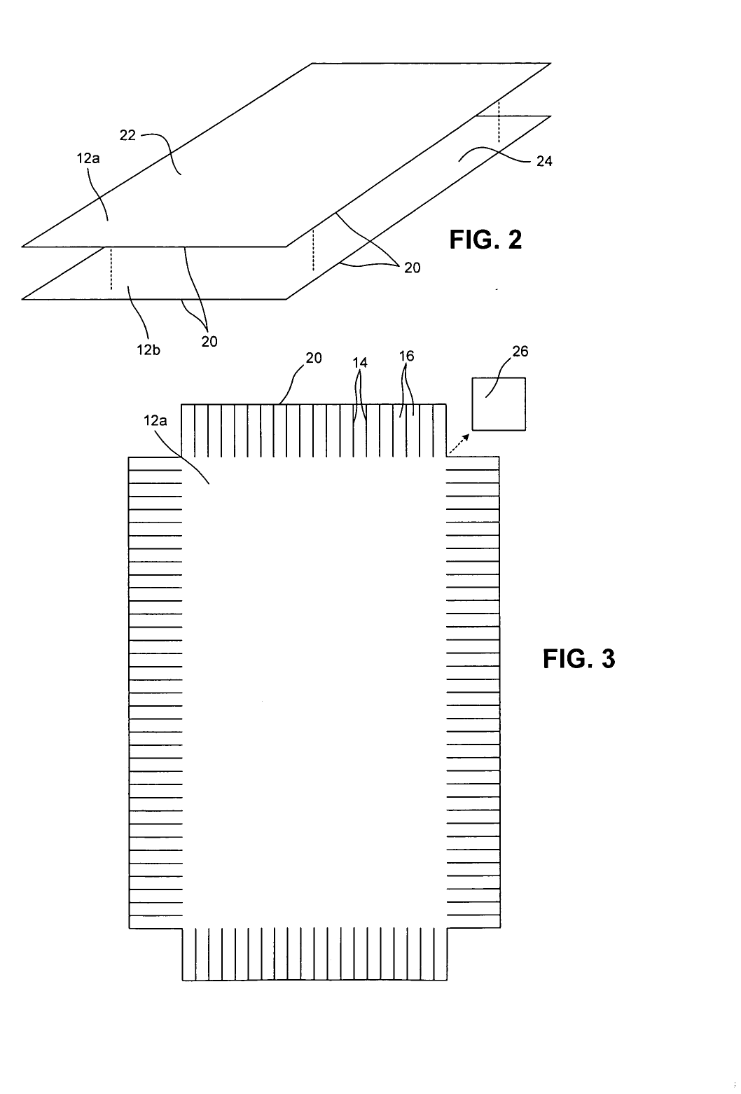

A method of assembling the throw 10 will now be described. The method includes providing one or more layers 12 of fabric material. For example, referring to FIG. 2, two layers 12 can be provided. The layers 12 can have approximately the same dimension. In one example, the layers 12 can be about 4 feet by about 5.5 feet, although larger and smaller sizes are contemplated as falling within the scope of the present invention. One or more of the layers 12 can be dyed or otherwise formed to have a pattern (e.g., flowers, stripes, sports team logo, etc.). The layers 12 need not have the same pattern and one layer 12 can be patterned while the other is formed from a solid color. Alternatively, each layer 12 can have a solid color.

The layers 12 can be stacked, one upon another, such that the edges 20 of each layer 12 are generally in vertical alignment. In this example, one layer 12 can be considered an upper or top layer 12a and the other a lower or bottom layer 12b. Depending on the type of material, the weave (if any), patterns printed or otherwise formed in the layer, the layers 12 can have a front side 22 and a back side 24. It may be desirous for the front side 22 of each layer 12 to face outward in the finished throw 10. Accordingly, when stacking the layers 12, the front side 22 of the bottom layer 12b can face downward and the front side 22 of the top layer 12a can face upward. In this manner, the back side 24 of each layer 12 are placed against one another.

Once stacked, the layers 12 can be cut to form the fringes 16. In one embodiment, each cut used to form the fringes 16 is made to each layer 12 at the same time. For example, one cutting motion can be simultaneously used to cut the top layer 12a and the bottom 12b. Cutting of the layers 12 can be carried out in any suitable manner, including using scissors or a rotary cutter (e.g., a sharpened wheel retained to handle that slices fabric by pinching the fabric between the wheel and a subjacent surface). A cutting guide, such as a jig, a ruler, a straight edge and so forth can be employed while cutting. Measuring and/or marking devices can be used to determine where various cuts should be made.

In one embodiment, assembly of the throw 10 can include cutting a rectangular shaped (e.g., square) portion 26 from each corner of the layers 12. The removed portions 26 do not form part of the throw 10. As best shown in FIG. 3, the removed portions 26 can have a length and a width corresponding to a desired length of the fringes 16 prior to knotting of the fringes 16. For instance, a square of about seven inches by about seven inches may be removed (e.g., cut out) from each layer 12 at each corner. The size of the removed portion 26 of layers 12 can be based on the preference of the person assembling the throw 10. An example range applicable to both the length and width of the removed portions 26 can be about four inches to about twelve inches, but this range is in no way intended to be limiting to the present invention. In fact, removal of material from the corners of the layers 12 is optional. If removed, the length and width of the removed portions 26 need not be equal to each other or equal to the length of the fringes 16.

To form the fringes 16, slits 14 can be cut into the layers 12. In one embodiment, the slits 14 are cut at a right angle to the corresponding edge 20 of the layers 12. In other embodiments, the slits 14 can be cut to be non-perpendicular to the edges 20. In the illustrated embodiment, slits 14 are cut along each edge 20 of the layers 12, but it is understood that slits 14 need not be cut along a selected edge(s) of each layer 12.

The lengths of the slits define the length of the fringes 16 and need not be equal to one another. In one embodiment, the slits 14 can have a length of about seven inches and, in one embodiment, the slits 14 can have a length of about four inches to about twelve inches, but this range is in no way intended to be limiting to the present invention.

The slits 14 can be cut at regular or irregular intervals. For instance, each slit can be spaced about one inch apart to make a series of fringes 16 that each have a width of about one inch. Wider and narrow fringes (e.g., fringe of about a half inch to about four inches in width) are contemplated, but example range is in no way intended to be limiting to the present invention. The fringes 16 need not have equal widths. Also, if desired, one or more fringes may be eliminated, e.g., by cutting them off. Eliminating one or more fringes may leave a wider space (or slit) between adjacent fringes. Also, if desired, one or more of the fringes may be shortened in length, e.g., by cutting some slits shorter in length (from the edge 20 toward the interior or center portion of the layer 12) than other slits or by cutting off part of a fringe. Also, if desired, although the slits and fringes are shown relatively straight, they may be formed in a desired pattern, one non-limiting example of which is an undulating or wave shape along the length of the slits and fringes.

In another embodiment, material can be removed to space the fringes apart from one another. For example, slits may be cut to form fringes 16 and then an unwanted fringe 16 disposed between a pair of desired fringes 16 can be removed. By removing certain fringes 16, the edges of the layers 12 may form a crenelated pattern prior to knotting. Other shapes and patterns may be formed by cutting at the discretion of the person assembling the throw.

Next, corresponding pairs of fringes 16 (e.g., one fringe 16 from the top layer 12a and one fringe 16 from the bottom layer 12b) can be knotted together. The knots 18 can be any suitable knot. For instance, illustrated in FIG. 1 are knots 18 formed by looping the fringes 16, then passing an end of the fringes 16 through the loop and drawing the end of the fringes 16 tight to constrict the loop around the fringe 16, thereby forming a knot. Such a knot will suffice to form a knot 18 in a fringe 16 that is not paired with a fringe 18 from another layer 12 (e.g., the case where the throw 10 is made from only one layer 12). Such a knot will also suffice to secure two fringes together when both fringes are held back-to-back during the knotting process. Other knots 18, and particularly knots 18 used to tie two or more fringes 16, can include bow knots, square knots and the like.

In the illustrated embodiment, where portions 26 are removed from the corners of the layers 12 during assembly, corners of the throw 10 can be defined by a junction 28 of a proximal end of a pair of corresponding fringes 30 located along a first edge 20 of the layers 12 and a proximal end of a pair of corresponding fringes 32 along a second edge 20 of the layers 12 adjacent the first edge 20.

As should be appreciated, the throw 10 can be assembly from a kit that includes, for example, a pair of layers 12 and a set of instructions. The instructions can set forth how to assemble the throw, including a direction to cut the layers such that each layer has corresponding fringes and a direction to knot corresponding fringes to thereby secure the first and second layers to each other. For example, the instructions can read as follows. Step 1, cut 7″ squares out of both pieces of fabric at each corner. Step 2, to make fringe(s), cut 7″ into the fabric at 1″ intervals around all four sides of both layers. Step 3, place the fabric layers wrong sides together and knot fringe pieces together using one strand from the top layer and one strand from the bottom. These steps can be repeated around all four edges of the layers. Tips for assisting in assembling the throw can be included with the instructions. One tip can include a statement suggesting that corresponding cuts should be made to both layers of fabric at the same time. In one embodiment, the instructions and/or tips can be printed on a band of packaging material (e.g., flexible card stock or plastic) that is wrapped around the layers to retain the layers in a folded and/or rolled configuration.

Although particular embodiments of the invention have been described in detail, it is understood that the invention is not limited correspondingly in scope, but includes all changes, modifications and equivalents coming within the spirit and terms of the claims appended hereto.

1. A fabric throw, comprising a first layer of fabric material and a second layer of fabric material wherein each layer defines a plurality of fringes along one or more edges of the layers, corresponding pairs of fringes being knotted together to secure the first and second layers to each other.

2. The throw according to claim 1, wherein the layers are made from polyester fleece material.

3. The throw according to claim 1, wherein a corner of the throw is defined by a junction of a proximal end of a pair of corresponding fringes located along a first edge of the layers and a proximal end of a pair of corresponding fringes along a second edge of the layers adjacent the first edge.

4. A method of assembling a fabric throw, comprising:
providing a first layer of fabric material and a second layer of fabric material;
cutting a plurality of slits along edges of the layers to form corresponding pairs of fringes from the layers; and
knotting corresponding pairs of fringes to secure the first layer to the second layer.

5. The method according to claim 4, further comprising removing a corner portion of each layer.

6. The method according to claim 5, wherein the length and width of the removed portions correspond to lengths of pairs of fringes forming a junction to define a corner of the throw.

7. The method according to claim 4, wherein the slits to define at least one pair of corresponding fringes are cut into each layer simultaneously.

8. The method according to claim 4, wherein the layers are made from polyester fleece material.

9. A kit for making a fabric throw, comprising:
a first layer of fabric material;
a second layer of fabric material; and
a set of instructions setting forth how to assemble the throw.

10. The kit according to claim 9, wherein the instructions include a direction to cut the layers such that each layer has corresponding fringes and a direction to knot corresponding fringes to secure the first and second layers to each other.

11. The kit according to claim 10, wherein the instructions further include a suggestion that corresponding cuts should be made to both layers of fabric at the same time.

12. The kit according to claim 9, wherein the layers are made from polyester fleece material.

13. The kit according to claim 9, wherein the instructions are printed on a band of packaging material that is wrapped around the layers to retain the layers in one of a folded configuration, a rolled configuration and combinations thereof.

14. A fabric throw includes at least two layers of fabric material, each layer defining a plurality of fringes along one or more edges of the layer, and corresponding pairs of fringes, at least one of one layer and one of a second layer, being knotted together to secure the layers to each other.

15. A kit for making a fabric throw includes at least two layers of fabric material, each layer defining a plurality of fringes along one or more edges of the layer, and corresponding pairs of fringes, at least one of one layer and one of a second layer, being arranged to be knotted together to secure the layers to each other.

16. A method of assembling a fabric throw that includes at least first and second layers of fabric-like material with fringes along an edge, includes knotting corresponding pairs of fringes to secure the first layer to the second layer.

17. A fabric assembly, comprising:
a first generally rectangular piece of fabric having a front side and a back side, and the first piece of fabric including fringes along each edge of the first piece of fabric; and
a second generally rectangular piece of fabric having a front side and a back side, and the second piece of fabric including fringes along each edge of the second piece of fabric, the fringes of the second piece of fabric having a one for one correspondence with the fringes of the first piece of fabric;
wherein the back side of the second piece of fabric contacts the back side of the first piece of fabric and each fringe from the first piece of fabric is knotted with the corresponding fringe from the second piece of fabric.

18. The fabric assembly according to claim 17, wherein the pieces of fabric are polyester fleece material.

19. The fabric assembly according to claim 17, wherein the first and second pieces of fabric have generally the same dimensions.

20. The fabric assembly according to claim 17, wherein generally rectangular sections of fabric have been removed from each corner of each of the first and the second pieces of fabric.

21. The fabric assembly according to claim 20, wherein the removed rectangular sections each have a length of about four inches to about twelve inches and a width of about four inches to about twelve inches.

22. The fabric assembly according to claim 17, wherein the fringes each have a width of about one half inch to about four inches.

23. A fabric assembly, comprising:
a first piece of fabric having a front side and a back side, and the first piece of fabric including fringes along edges of the first piece of fabric; and
a second piece of fabric of generally the same size and shape as the first piece of fabric and having a front side and a back side, and the second piece of fabric including fringes along edges of the second piece of fabric;
wherein the back side of the second piece of fabric faces the back side of the first piece of fabric and fringes from the first piece of fabric are knotted with respective fringes from the second piece of fabric.

24. The fabric assembly according to claim 23, wherein the pieces of fabric are polyester fleece material.

25. The fabric assembly according to claim 23, wherein the first and second pieces of fabric have generally the same dimensions.

26. The fabric assembly according to claim 23, wherein generally rectangular sections of fabric have been removed from each corner of each of the first and the second pieces of fabric.

27. The fabric assembly according to claim 26, wherein the removed rectangular sections each have a length of about four inches to about twelve inches and a width of about four inches to about twelve inches.

28. The fabric assembly according to claim 23, wherein the fringes each have a width of about one half inch to about four inches.

29. A method of assembling a fabric assembly, comprising:
providing first and second generally rectangular pieces of fabric having a front side and a back side;
placing the first piece of fabric over the second piece of fabric so that the back side of the first piece of fabric faces the back side of the second piece of fabric;
removing a section of fabric from corners of the first and second pieces of fabric;
creating plural slits along edges of the first and second pieces of fabric so that each piece of fabric has fringes, the fringes of the first piece of fabric having a one to one correspondence with the fringes of the second piece of fabric; and
knotting each fringe from the first piece of fabric with the corresponding fringe of the second piece of fabric to secure the first piece of fabric to the second piece of fabric.

30. The method according to claim 29, wherein the creating slits includes simultaneously cutting the first and second pieces of fabric.

31. The method according to claim 29, wherein the removing sections from corners of the pieces includes simultaneously cutting the first and second pieces of fabric.

32. The method according to claim 29, wherein the provided pieces of fabric are polyester fleece material.

33. The method according to claim 29, wherein the provided pieces of fabric are generally the same dimensions.

34. A method of assembling a blanket, comprising:
laying a first piece of fabric on top of a second piece of fabric with back sides of the pieces together, the pieces cut to be rectangular;
trimming away a generally rectangular section of fabric at each corner of the pieces;
cutting into edges of the pieces to form fringes along the edges; and
joining pieces of fabric by knotting fringes of the top piece of fabric and fringes of the bottom piece of fabric.

35. The method according to claim 34, further comprising marking at least one of the pieces of fabric to assist in enhancing accuracy of the cuts to form the fringes.

36. The method according to claim 34, further comprising marking at least one of the pieces of fabric to assist in enhancing accuracy of the trimming away of rectangular sections.

37. The method according to claim 34, wherein at least one piece of fabric includes a pattern.

38. The method according to claim 34, wherein the trimmed away sections each have a length of about four inches to about twelve inches and a width of about four inches to about twelve inches.

39. The method according to claim 34, wherein the fringes each have a width of about one inch.

40. The method according to claim 34, wherein the fringes each have a width of about one half inch to about four inches.

41. A method of assembling a blanket, comprising:
laying first and second layers of fabric together with back sides together,
cutting out a generally rectangular section of fabric at each corner of the layers of fabric;
cutting into edges of the layers of fabric to form fringes along the edges; and
knotting fringes together using one fringe from each layer of fabric.

42. The method according to claim 41, wherein the cut out rectangular sections are squares.

43. The method according to claim 41, further comprising repeating the knotting around all edges of the layers of fabric.

44. The method according to claim 41, wherein one layer has a pattern and the other layer has a solid color.

45. The method according to claim 41, further comprising marking at least one of the layers of fabric to assist in enhancing accuracy of the cuts to form the fringes.

46. The method according to claim 41, further comprising marking at least one of the layers of fabric to assist in enhancing accuracy of the cutting out of the generally rectangular sections.

47. The method according to claim 41, wherein at least one layer of fabric includes a pattern.

48. The method according to claim 41, wherein the cut out generally rectangular sections each have a length of about four inches to about twelve inches and a width of about four inches to about twelve inches.

49. The method according to claim 41, wherein the fringes each have a width of about one inch.

50. The method according to claim 41, wherein the fringes each have a width of about one half inch to about four inches.
